(19) United States
(12) Patent Application Publication
(10) Pub. No.: US 2024/0242882 A1
(43) Pub. Date: Jul. 18, 2024

(54) WIRELESS CHARGING CABLE, COIL STRUCTURE AND PRODUCING METHOD THEREOF, AND WIRELESS CHARGING DEVICE

(71) Applicant: LUXSHARE PRECISION INDUSTRY COMPANY LIMITED, SHENZHEN (CN)

(72) Inventors: Kuan-Ying HO, SHENZHEN (CN); Yu-Pei HUANG, SHENZHEN (CN); Yao-Nien CHUNG, SHENZHEN (CN); Chih-Yung WU, SHENZHEN (CN)

(73) Assignee: LUXSHARE PRECISION INDUSTRY COMPANY LIMITED, SHENZHEN (CN)

(21) Appl. No.: 18/532,135

(22) Filed: Dec. 7, 2023

(30) Foreign Application Priority Data
Jan. 16, 2023 (CN) 202310085814.9

(51) Int. Cl. H01F 41/07; H01B 3/30; H01B 7/02; H01B 7/20; H01F 27/30; H01F 41/074; H02J 50/00; H02J 50/10

(52) U.S. Cl. CPC H01F 41/07; H01B 3/30; H01B 7/0216; H01B 7/207; H01F 27/306; H01F 41/074; H02J 50/005; H02J 50/10; G06F 3/0395

(57) ABSTRACT

The present invention provides a wireless charging cable, a wireless charging coil structure and a producing method thereof, and a wireless charging device. The wireless charging cable has a conductive wire, an alloy layer and an insulation layer. The alloy layer is electroplated on an outer surface of the conductive wire and composed of nickel and iron, the insulation layer is coated on an outer surface of the alloy layer, wherein a better range of the cable diameter of the wireless charging cable is between 0.1 and 0.5 mm. The wireless charging coil structure has a sewed object and a sewing wire material including the wireless charging cable. The sewing wire material is sewed on the sewed object, and the wireless charging cable is sewed to become a wireless charging coil.

### CROSS REFERENCE TO RELATED APPLICATION

This application claims the priority benefits of Chinese Patent Application Serial Number 202310085814.9, filed on Jan. 16, 2023, the full disclosure of which is incorporated herein by reference.

### BACKGROUND

### Technical Field

The present invention is in related to the technical field of wireless charging coil, more particularly to a wireless charging cable, a coil structure and a producing method thereof, and a wireless charging device.

### Related Art

Presently, when the existing AC coil for wireless charging is manufactured, a ferrite magnetic sheet shall be a base, and the coil is fixed on the hard magnetic sheet through glue or adhesive tape. However, further speaking, the above-mentioned coils are fixed on the hard magnetic sheet via glue or adhesive tape, the structure of the coil may not be stable enough, and the adhesion will be unstable after long-term use as well. In addition, by means of stacking the coil and magnetic sheet will increase the thickness and volume thereof. Therefore, the wireless charging efficiency may not be good enough since the connection strength between the coil and magnetic sheet is weak, so as to cause the gaps happen among the structures. In addition, the current PCB and FPC coils shall be added by ferrite, in order to increase the thickness and weight of the copper foil traces, since the electrical characteristics of the copper foil traces are so poor. However, the above corrections will lead to the problem that the copper foil traces cannot be bent.

### SUMMARY

The present invention discloses a wireless charging cable, a wireless charging coil structure and a producing method thereof, and a wireless charging device, which objective is to solve the problem that of low strength and insufficient flexibility of wires in the existing wireless charging coil structure, and it is not easy to be used as wires for sewing and making wireless charging wires.

For solving aforesaid technical problems, the present invention will be discussed as following.

In the first aspect, the present invention provides a wireless charging cable, which comprises at least one conductive wire, an alloy layer and an insulation layer. The alloy layer is electroplated on an outer surface of the conductive wire and composed of nickel and iron, the insulation layer is coated on an outer surface of the alloy layer, wherein a better range of the cable diameter of the wireless charging cable is between 0.1 and 0.5 mm.

In one of the embodiments, there are the plurality of conductive wires and the conductive wires are twisted with each other.

In one of the embodiments, a best number of the conductive wire is four, all of the conductive wires are twisted with each other, and the cable diameter of the wireless charging cable is within a range of 0.2 to 0.3 mm.

In one of the embodiments, a wire diameter of the conductive wire is within a range of 0.06 to 0.1 mm.

In one of the embodiments, a ratio for the nickel and iron in the alloy layer is 80:20.

In one of the embodiments, a thickness of the alloy layer is within a range of 0.002 to 0.008 mm.

In one of the embodiments, the insulation layer has a first insulation layer and/or a second insulation layer, the first insulation layer is polyamide, and the second insulation layer is polyurethane.

In one of the embodiments, a thickness of the first insulation layer is within a range of 0.011 to 0.021 mm.

In one of the embodiments, a thickness of the second insulation layer is within a range of 0.007 to 0.17 mm.

In the second aspect, the present invention provides a method for producing a wireless charging coil structure comprising the following steps of: preparing the wireless charging cable in any of claim 1 to claim 10; and sewing the wireless charging cable on a sewed object, and sewing the wireless charging cable to become a wireless charging coil.

In one of the embodiments, after the step of preparing the wireless charging cable, the following step is that of inserting the wireless charging cable into a sewing needle.

In one of the embodiments, after the step of preparing the wireless charging cable, the following steps are that of: winding the wireless charging cable around a bobbin of a sewing machine; and using the sewing machine to perform a double-thread interlocking sewing on the fixing line and the wireless charging cable.

In one of the embodiments, the wireless charging coil adopts a multi-strand parallel winding method, and has the plurality of wireless charging cables, the plurality of the wireless charging cables are sewed on the sewed object at intervals.

In the third aspect, a third party provides a wireless charging device, which comprises the sewed object and the wireless charging cable in the first aspect. The wireless charging cable is sewed on the sewed object, and the wireless charging cable is sewed to become the wireless charging coil.

In one of the embodiments, the present invention further comprises a fixing line, which is sewed on a first surface of the sewed object, the wireless charging cable is sewed on a second surface of the sewed object, the first surface and the second surface are corresponded with each other, and the fixing line and the wireless charging wire are interlaced and interlocked up and down.

In one of the embodiments, the wireless charging coil is a signal structure of a single-ended signal or a differential wiring.

In one of the embodiments, a material of the sewed object is selected from the group consisting of: cotton, nylon, linen, fiber, animal leather, pure wool, rayon, silk, acrylic, and artificial leather, and the sewed object is produced by the group consisting of: flat stitch, knitting, screw stitch, double reverse stitch, mesh stitch, raschel, elastic knitting, chemical bonding, hot-melt bonding and complexing.

In the fourth aspect, the present invention provides wireless charging device, which comprises a first surface layer, the wireless charging coil structure provided by the third party, a filling layer, and a second surface layer. The wireless charging coil structure is disposed on the first surface layer. The filling layer is disposed on the wireless charging coil structure. The second surface layer is disposed on the filling layer. The wireless charging coil of the wireless charging coil structure has an electronic connection end, which is through the second surface layer and disposed on the second surface layer.

In one of the embodiments, the present invention further comprises a charging module and a charging wire, wherein the charging wire is electrically connected with the charging module, the charging module is disposed on the second surface layer, and the charging module is electrically connected with the electronic connection end.

The present invention provides a wireless charging cable, a wireless charging coil structure and a producing method thereof, and a wireless charging device. The wireless charging cable has a conductive wire, an alloy layer and an insulation layer. The alloy layer is electroplated on an outer surface of the conductive wire and composed of nickel and iron, the insulation layer is coated on an outer surface of the alloy layer, wherein a range of the cable diameter of the wireless charging cable is between 0.1 and 1 mm. The wireless charging coil structure has a sewed object and a sewing wire material including the wireless charging cable. The sewing wire material is sewed on the sewed object, and the wireless charging cable is sewed to become a wireless charging coil. In the invention, a wireless charging coil structure is fabricated by arranging wireless charging cables in a sewing manner, and then a wireless charging device is manufactured using the wireless charging coil structure. In this way, it is more convenient to manufacture the wireless charging coil structure by tailoring. The wireless charging device produced by the above method can effectively improve the electrical characteristics and charging efficiency, and at the same time reduce the thickness and weight of the coil, so that it is easy to carry and use.

The accompanying drawings are incorporated in and constitute a part of this application and, together with the description, serve to explain the principles of the invention in general terms. Like numerals refer to like parts throughout the disclosure.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 illustrates a schematic view of a first embodiment of the wireless charging cable of the present invention;

FIG. 2 illustrates a schematic view of a second embodiment of the wireless charging cable of the present invention;

FIG. 3 illustrates another schematic view of the second embodiment of the wireless charging cable of the present invention;

FIG. 4 illustrates a flow chart of the method for producing a wireless charging coil structure of present invention;

FIG. 5 illustrates another flow chart of the method for producing a wireless charging coil structure of present invention;

FIG. 6 illustrates a schematic producing view of the wireless charging coil structure of the present invention;

FIG. 7 illustrates another schematic producing view of the wireless charging coil structure of the present invention;

FIG. 8 illustrates another schematic producing view of the wireless charging coil structure of the present invention;

FIG. 9 illustrates a schematic view of a first embodiment of the wireless charging coil of the present invention;

FIG. 10 illustrates a schematic view of a second embodiment of the wireless charging coil of the present invention;

FIG. 11 illustrates a schematic view of a third embodiment of the wireless charging coil of the present invention;

FIG. 12 illustrates a schematic view of a fourth embodiment of the wireless charging coil of the present invention;

FIG. 13 illustrates a schematic view of a fifth embodiment of the wireless charging coil of the present invention;

FIG. 14 illustrates a schematic view of a sixth embodiment of the wireless charging coil of the present invention;

FIG. 15 illustrates a schematic view of the wireless charging device of the present invention; and

FIG. 16 illustrates another schematic view of the wireless charging device of the present invention.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

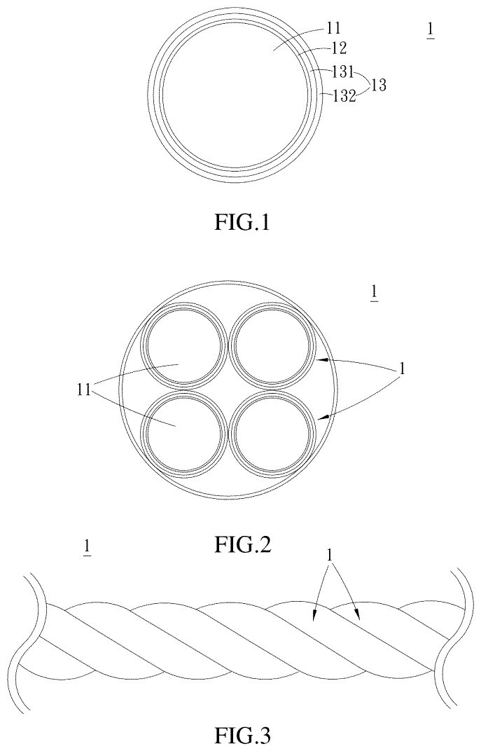

Please refer to FIG. 1, which illustrates a schematic view of a first embodiment of the wireless charging cable of the present invention. As shown in figure, a wireless charging cable 1 of the present invention includes at least one conductive wire 11, an alloy layer 12 and an insulation layer 13. The alloy layer 12 is electroplated on an outer surface of the conductive wire 11 and composed of nickel and iron. The insulation layer 13 is coated on an outer surface of the alloy layer 12. A cable diameter of the wireless charging cable 1 is within a range of 0.1 to 1 mm, but the better range of the cable diameter of the wireless charging cable 1 is between 0.1 and 0.5 mm.

As to the embodiment, the conductive wire 11 is made of copper, and the conductor wire 11 is drawn into a wire diameter between 0.06 and 0.1 mm, and the better range of the cable diameter is between 0.083 and 0.087 mm, in addition, the best size is 0.085 mm. The alloy layer 12 is coated on the outer surface of the conductive wire 11, so as to form a thickness range, which is in between 0.002 and 0.008 mm. Additionally, the best thickness of the alloy layer 12 is 0.002 mm. The ratio of nickel and iron is 75-85:15-25, and the best ratio is 80:20. Not only that the alloy layer 12 protects the conductive wire 11, but also enhancing the strength of the conductive wire 11 for facilitating the following sewing processes. The alloy layer 12 has excellent oxidation resistance, corrosion resistance and high temperature resistance, and can reduce high frequency loss in high frequency applications (such as high frequency wireless charging, etc.).

The insulation layer 13 is coated on the outer surface of the alloy layer 12, and has a first insulation layer 131 and/or a second insulation layer 132. The first insulating layer 131 is polyurethane (PU), and the second insulating layer 132 is polyamide (PA). PU is coated on the outer surface of the alloy layer 12 in advance, and the thickness of the first insulation layer 131 is within the range of 0.011 to 0.021 mm, but the better range is between 0.015 and 0.017 mm. Secondly, PA is coated on the outer surface of the first insulation layer 131, in order to form the thickness of the second insulation layer 132 is in the range of 0.007 to 0.017 mm, and also the better range is between 0.009 and 0.017 mm. In this way, the wireless charging cable 1 is done, as shown in FIG. 1, and can be suitable for high frequency wireless charging.

The present embodiment may not limit the material of the wireless charging cable 1. If it is on demand, the alloy layer 12 can be coated on the outer side of the conductive wire 11. The metal doped in the alloy layer 12 can be increased or decreased according to the efficacy required by the user, and the thickness of the alloy layer 12 can be increased or decreased based on the cable strength on demand as well. Finally, an insulating layer 13 is added on the outer side of the alloy layer 12 to prevent electrical short circuits from being waterproof or dustproof. The wireless charging cable 1 suitable for sewing is produced in the above-mentioned manner.

Please refer to FIG. 2 and FIG. 3, which illustrate a schematic view of a second embodiment of the wireless charging cable of the present invention and another schematic view. As shown in figures, the difference between the second embodiment and the first embodiment is the number of the wireless charging cable. In the present embodiment, the number of the wireless charging cable is between 1 and 16. The wireless charging cables 1 are twisted with each other if the multiple wireless charging cables are provided, as shown in FIG. 3. The number of the wireless charging cable 1 is 4, as shown in FIG. 2. Obviously, the four wireless charging cables 1 are twisted together, and the cable diameter of each of the four wireless charging cables 1 is in the range of 0.15 to 0.25 mm, but the best cable diameter is 0.2 mm. In this embodiment, by increasing the number of wireless charging cables 1 and twisting the wireless charging cables 1, not only the structural strength of the wireless charging cables 1 can be improved, but also the electrical performance of the wireless charging cables 1 can be further improved, so as to be suitable for wireless charging receiving and transmitting coils of Magnetic Resonance and NFC WLC (Near Field Communication Warless Charge).

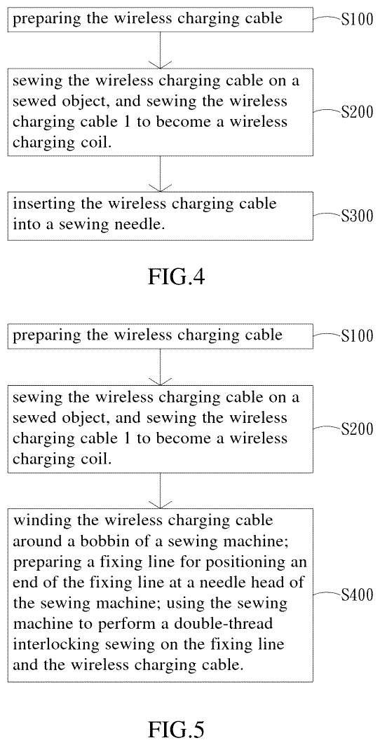

Please refer to FIG. 4 and FIG. 5 together, which illustrate a flow chart of the method for producing a wireless charging coil structure of present invention and another flow chart. As shown in figures, the method for producing the wireless charging coil structure has the following steps of:
(S100) preparing the wireless charging cable 1; and
(S200) sewing the wireless charging cable 1 on a sewed object 2, and sewing the wireless charging cable 1 to become a wireless charging coil 3.

The objective of the present invention is to make the wireless charging cable to be as a sewing wire material, therefore that is to sew the wireless charging cable 1 on the sewed object 2 by needle and thread. According to aforesaid descriptions, the wireless charging cable 1 can be sewed manually or mechanically, and the following descriptions will be discussed in detail.

With reference to FIG. 4, the first type is the manual sewing. After the step (S200), a step (S300) is continuous and of inserting the wireless charging cable 1 into a sewing needle. User manually inserts the wireless charging cable 1 into the sewing needle, and sews the sewed object 2 via the sewing needle. Hence, the wireless charging cable 1 is sewed on the sewed object 2 to construct the structure of the wireless charging coil 3.

Regarding to FIG. 5, the second type is mechanical sewing. After the step (S200), a step (S400) is continuous and of winding the wireless charging cable 1 around a bobbin 41 of a sewing machine 4; preparing a fixing line 21 for positioning an end of the fixing line 21 at a needle head 42 of the sewing machine 4; using the sewing machine 4 to perform a double-thread interlocking sewing on the fixing line 21 and the wireless charging cable 1. Therefore, the wireless charging cable 1 is sewed on the sewed object 2 to construct the structure of the wireless charging coil 3.

For further discussions, the wireless charging coil 3 adopts a multi-strand parallel winding method, and the plurality of wireless charging cables 1 are sewed to become the plurality of wireless charging coils 3, wherein the plurality of the wireless charging coils 3 are sewed at intervals, and the interval arrangement may be an arrangement at equal intervals or an arrangement at unequal intervals. In other words, the wireless charging cable 1 forms the path of the wireless charging coil 3 in advance, then the several newly added wireless charging cables 1 are added along the path, continuously the several newly added wireless charging coils 3 are individually and inwardly shifted or individually and outwardly shifted with equal interval for arrangement. The number of winding strands can be increased or decreased according to the needs of users without changing the thickness of the overall structure, and the method of increasing the number of winding strands by sewing is relatively simple and uncomplicated.

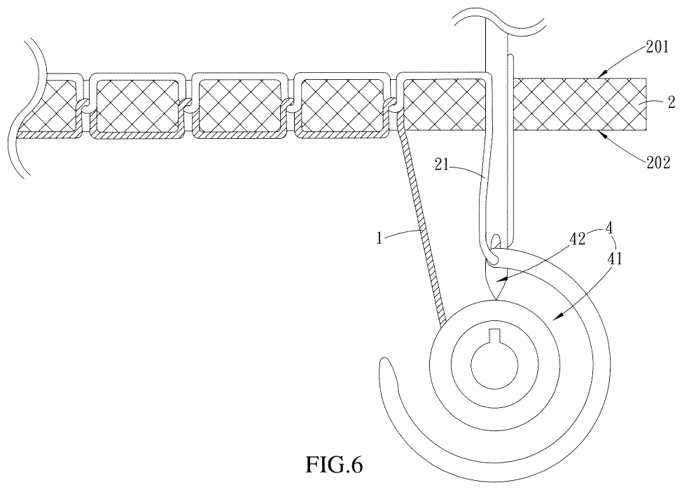

In reference to FIG. 6, which illustrates a schematic producing view of the wireless charging coil structure of the present invention. As shown in figure, the wireless charging coil structure 5 has the sewed object 2 and the wireless charging coil 3. The wireless charging cable 1 is sewed on the sewed object 2, and then the wireless charging cable 1 is sewed to become a wireless charging coil 3. The wireless charging coil structure 5 has a fixing line 21, which is sewed on a first surface 201 of the sewed object 2. The wireless charging cable 1 is sewed on a second surface 202 of the sewed object 2, wherein the first surface 201 and the second surface 202 are corresponded with each other, and the fixing line 21 and the wireless charging cable 1 are interlaced and interlocked up and down. What is more, the fixing line 21 and the wireless charging cable 1 are firmed up on the sewed object 2 through the double-thread interlocking sewing.

Further, a material of the sewed object 2 is selected from the group consisting of: cotton, nylon, linen, fiber, animal leather, pure wool, rayon, silk, acrylic, and artificial leather, and the sewed object 2 is produced by the group consisting of: flat stitch, knitting, screw stitch, double reverse stitch, mesh stitch, raschel, elastic knitting, chemical bonding, hot-melt bonding and complexing. Using the above method, non-woven fabrics, nylon fabrics, cotton fabrics, leather products, etc. are made as the base material for sewing the wireless charging cable 1. This embodiment does not limit the material or manufacturing method of the sewed object 2. The sewed object 2 can be any material of being processed by embroidery and sewing, and it can be an object where the wireless charging cable 1 is sewed according to the needs of the user. The structure of the above-mentioned sewed object 2 has the features of flexibility and softness, so that the wireless charging coil structure 5 is easy to be curled and stored. At the same time, materials such as breathable, environmentally friendly, waterproof, fireproof or strong toughness can also be selected according to requirements. The wireless charging coil structure 5 made of the above materials is beneficial to heat dissipation. In addition, the wireless charging cable 1 is not limited to be sewed on engineering plastics, which is beneficial to the manufacture of a three-dimensional charging structure.

The embodiment adopts the way of machine or manual operation to fix the wireless charging cable 1 on the sewed object 2 for different types of wireless charging coil structure 5. The wireless charging cable 1 can be used with embroidery sewing machines for automatic production, and is suitable for 6.78 Mhz and 13.56 Mhz high-frequency wireless charging. This embodiment is not subjected to the manufacturing process of forming and assembling traditional winding equipment. The method of winding and assembling through embroidery and sewing technology has high design flexibility, and the manufacturing freedom of the wireless charging coil structure 5 is high, and the manufacturing cost is low. From another view angle, the embodiment may not only limit the user machines the wireless charging cable 1 by way of the sewing machine 4. The wireless charging cable 1 of this embodiment is a thread that can be sewed, so the user can also make the wireless charging coil structure 5 by hand, or use any material that can sew the wireless charging cable 1 on it to make the wireless charging coil structure 5.

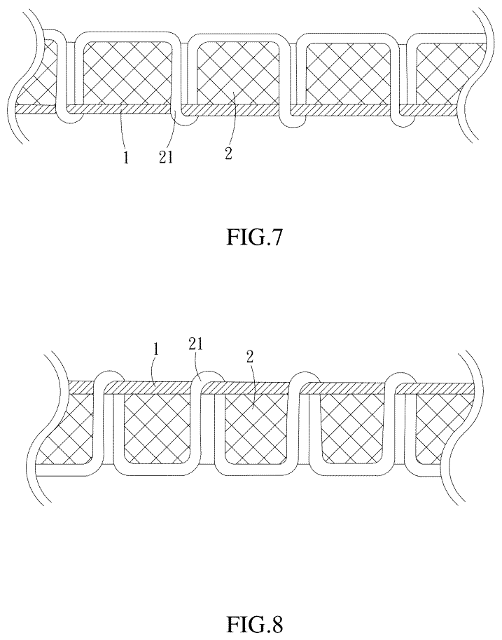

With regard to FIG. 7 and FIG. 8, which illustrate another schematic producing view of the wireless charging coil structure of the present invention and a third schematic producing view. As shown in figures, the embodiment provides another two producing ways for the wireless charging coil structure 5. According to FIG. 5, the wireless charging wire 1 is disposed on the first surface 201 of the sewed object 2 in a straight line, and then passes through the sewed object 2 from the second surface 202 through the fixing line 21, and the wireless charging cable 1 is fixed on the first surface 201 of the sewed object 2 by hooking. In FIG. 6, the wireless charging line 1 is set on the second surface 202 of the sewed object 2 in a straight line, and then the fixing line 2 is passed through the sewed object 2 from the first surface 201, wherein the wireless charging cable 1 is fixed on the first surface 201 of the sewed object 2. The difference between the above two ways is the direction of hooking, and it is on demand.

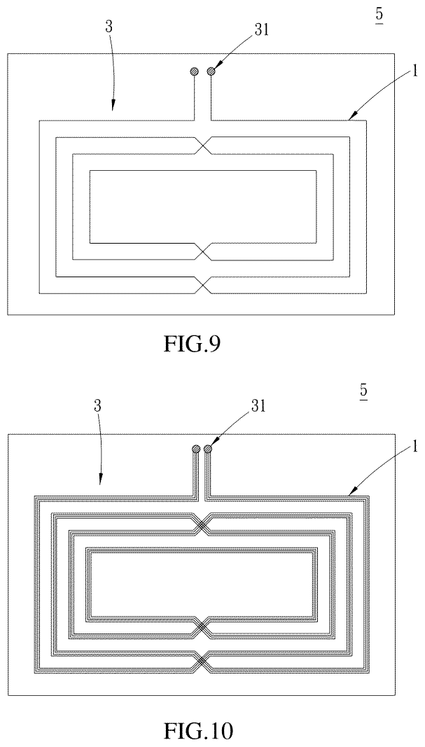

Regarding FIG. 9 to FIG. 14, which illustrate six schematic views of a first embodiment to a sixth embodiment of the wireless charging coil of the present invention. As shown in figures, the wireless charging coil 3 is designed as a signal structure of a single-ended signal or a differential wiring. The following descriptions will be discussed for the multiple types of the wireless charging coil 3 in detail.

Again, with reference to FIG. 9, which wireless charging coil 3 is the signal structure of the differential wiring, and the wireless charging coil 3 is composed of four twisted wireless charging cables 1, and forms four sets of wireless charging cables. In other words, there are sixteen wireless charging cables 1. The four sets of wireless charging cables 1 are sewed with differential routing and winding in the manner of four sets of co-bit sewing. The structure of the wireless charging coil 3 is wound four times in total, and the sewing method of the differential wiring is distinguished by the two ends of the wiring, which are divided into a left half area and a right half area. Compared with the coils in the left half area and the right half area, the coils are equidistant, equal in length and symmetry. The differential wire winding method of this embodiment has strong anti-interference ability, and suppresses electromagnetic interference (EMI). Further, it has an average wire path and relatively uniform electric field distribution. Again, in regard to FIG. 10, compared with the first embodiment, the present embodiment adopts the way of winding that is different from the first embodiment. The sewing method of the wireless charging coil 3 in this embodiment is also a differential wire winding sewing. The wireless charging coil 3 of this embodiment adopts the parallel winding method of four sets of wireless charging cables 1. The wireless charging coil 3 includes four sets of wireless charging cables 1 and the four sets of wireless charging cables 1 are sewed on the sewed object at intervals. More, the interval between the two adjacent wireless charging cables 1 is 1 mm.

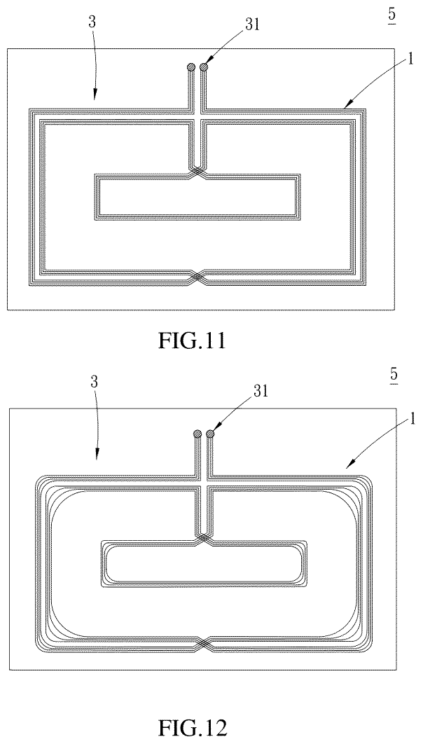

Please refer to FIG. 11, the difference between the present embodiment and the second embodiment is the winding method. As to the present embodiment, which adopts the parallel winding method of four sets of wireless charging cables 1, and the sewing method is a differential wire winding sewing as well. The winding method of this embodiment adopts the winding method of the inner and outer rings, and the shortest distance between the inner ring and the outer ring is 33 mm.

As for FIG. 12, compared with the third embodiment, the present embodiment has a winding structure that differs from the third embodiment. In this embodiment, the design of routing and winding is further aimed at the winding structure of the corners. The wireless charging cable 1, sewed to the corner, is sewed in the way of a guide angle, and the interval between the wireless charging cables 1 adjacent to the corner is increased. In this way, it is beneficial to the balance of the whole power field, and it will not cause the strengthening of the power field of the four corners because the number of the cordless charging cables 1 is too dense. Generally speaking, the field strength of a straight charging cable 1 is weak, which leads to the problem of the whole field strength being different. The present embodiment is suitable for a signal structure of a single-ended signal or a differential wiring of the wireless charging coil 3.

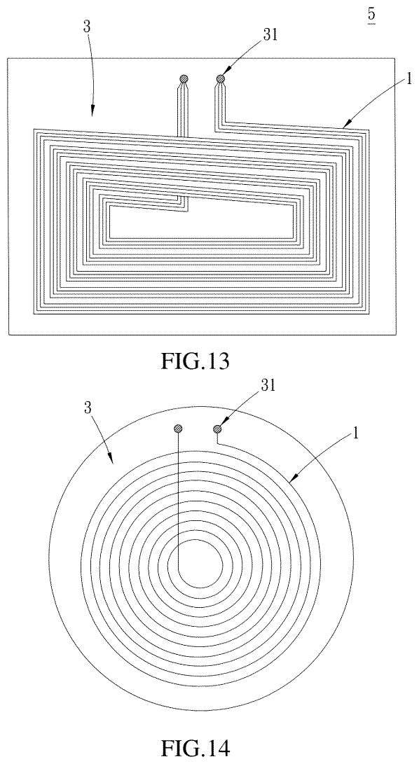

In regard to FIG. 13, compared with the first embodiment, the present embodiment has a winding structure that differs from the first embodiment. The present embodiment is the signal structure of the single-ended signal, which adopts the parallel winding method of four sets of wireless charging cables 1, and the sewing method is a single-ended winding sewing. The first end of the four groups of wireless charging cables 1 is sequentially set from the outer ring to the inner ring, and then pulled out from the bottom of each ring to form the second end.

In connection with FIG. 14, compared with the fifth embodiment, the present embodiment has a winding structure that differs from the fifth embodiment. The present embodiment is also the signal structure of the single-ended signal. The wireless charging cable 1 is wound in a circle, and the first end of the wireless charging cable 1 is set from the outer ring to the inner ring in sequence, and then pulled out from the bottom of each ring to form the second end.

The above first embodiment to the fourth embodiment may not limit the winding method and structure of the coil, but the winding method and structure of the coil can be demanded by users, in order to provide different effects in response to different needs.

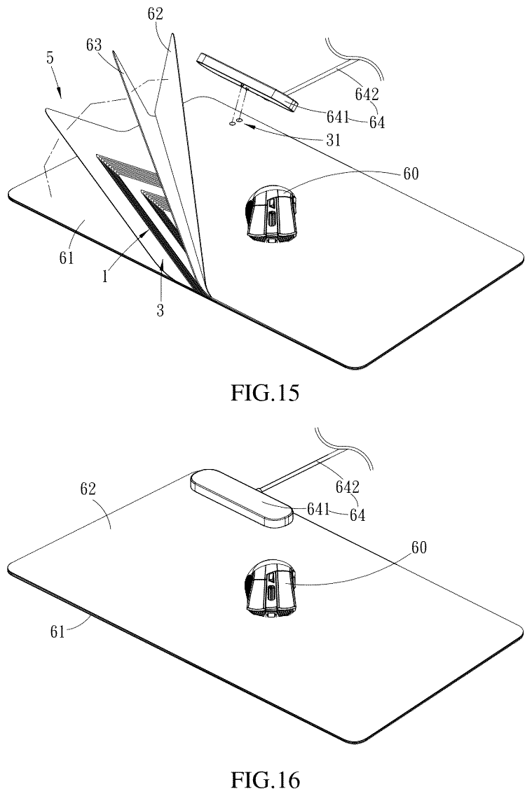

Please refer to FIG. 15 and FIG. 16 together, which illustrate a schematic view of the wireless charging device of the present invention and another schematic view. As shown in figures, a wireless charging device 6 includes a first surface layer 61, the wireless charging coil structure 5 and a second surface layer 62. The wireless charging coil structure 5 is disposed on the first surface layer 61. The second surface layer 62 covers the wireless charging coil structure 5 and is disposed on the first surface layer 61. Additionally, the wireless charging device 6 further has a filling layer 63, which is to fill between the first surface layer 61 and the second surface layer 62. The filling layer 63 covers and fills the wireless charging coil structure 5 as a wireless charging coil structure.

Moreover, the wireless charging coil 3 of the wireless charging coil structure 5 has an electronic connection end 31, which is through the second surface layer 62 and disposed on the second surface layer 62. The electrical connection end 31 may have multiple electrical connection points, such as USB-A, USB-C, etc., and the above electrical connection points can be designed according to user requirements. The wireless charging device 6 further has a charging structure 64, which includes a charging module 641 and a charging wire 642, wherein the charging wire 642 is electrically connected with the charging module 641, the charging module 641 is disposed on the second surface layer 62, the charging module 641 is electrically connected with the electronic connection end 31. Beyond that, the charging module 641 and the charging wire 642 provide electric power to the wireless charging coil structure 5.

In the embodiment, the first surface layer 61 is the design of anti-slip material or structure, and used to disposed on a table. The wireless charging coil structure 5 is the usage of charging. The filling layer 63 is to protect the wireless charging coil structure 5 for being a cushion structure of anti-collision or compression. The second surface layer 62 is a charging surface to provide any electronic device which can accommodate the electromagnetic coil for charging. The second surface layer 62 may be designed a surface with decoration patterns. The first surface layer 61 and the second surface layer 62 are the outer surfaces of the wireless charging device 6 and are flame retardant.

According to FIG. 11, the structure of the wireless charging device 6 is a flat surface structure, which can be used as a mouse pad for the sliding of the mouse 60. Therefore, the second surface layer 62 has a smooth surface for sliding the mouse. The wireless charging device 6 is able to charge the mouse 6. Among them, the communication structure of the mouse 60 is in-band communication through the power carrier, which can avoid the signal authorization method at both ends. This embodiment is suitable for the demand of a low-power one-to-one charging solution.

In addition, a PCB module is between the charging module 64 and the wireless charging coil structure 5. The charging module 64 is an electronic connection structure and directly and firmly disposed at the electronic connection end 31 of the second surface layer 62. Or, the charging module 64 is an electrical assembly structure and firmly disposed at the electronic connection end 31 of the second surface layer 62. In other words, the charging module 64 corresponds the electronic connection end 31 of the second surface layer 62, and the dimensions of the wireless charging coil structure 5 may not be limited. As aforesaid from other parts, the dimensions of the wireless charging coil structure 5 are on demand.

As a conclusion, the present invention provides a wireless charging cable, a wireless charging coil structure and a producing method thereof, and a wireless charging device. The wireless charging cable has a conductive wire, an alloy layer and an insulation layer. The alloy layer is electroplated on an outer surface of the conductive wire and composed of nickel and iron, the insulation layer is coated on an outer surface of the alloy layer, wherein a better range of the cable diameter of the wireless charging cable is between 0.1 and 0.5 mm. The wireless charging coil structure has a sewed object and a sewing wire material including the wireless charging cable. The sewing wire material is sewed on the sewed object, and the wireless charging cable is sewed to become a wireless charging coil. In the invention, a wireless charging coil structure is fabricated by arranging wireless charging cables in a sewing manner, and then a wireless charging device is manufactured using the wireless charging coil structure. In this way, it is more convenient to manufacture the wireless charging coil structure by tailoring.

Although the present disclosure is disclosed in the foregoing embodiments, it is not intended to limit the present disclosure. Changes and modifications made without departing from the spirit and scope of the present disclosure belong to the scope of the claims of the present disclosure. The scope of protection of the present disclosure should be construed based on the following claims.

1. A wireless charging cable, comprising:
at least one conductive wire;
an alloy layer, electroplated on an outer surface of the conductive wire, composed of nickel and iron; and
an insulation layer, coated on an outer surface of the alloy layer;
wherein a cable diameter of the wireless charging cable is within a range of 0.1 to 1 mm.

2. The wireless charging cable according to claim 1, wherein a better range of the cable diameter of the wireless charging cable is between 0.1 and 0.5 mm.

3. The wireless charging cable according to claim 2, wherein there are the plurality of conductive wires, the conductive wires being twisted with each other.

4. The wireless charging cable according to claim 2, wherein a best number of the conductive wire is four, all of the conductive wires being twisted with each other, the cable diameter of the wireless charging cable being within a range of 0.2 to 0.3 mm.

5. The wireless charging cable according to claim 1, wherein a wire diameter of the conductive wire is within a range of 0.06 to 0.1 mm.

6. The wireless charging cable according to claim 1, wherein a ratio for the nickel and iron in the alloy layer is 80:20.

7. The wireless charging cable according to claim 1, wherein a thickness of the alloy layer is within a range of 0.002 to 0.008 mm.

8. The wireless charging cable according to claim 1, wherein the insulation layer has a first insulation layer and/or a second insulation layer, the first insulation layer being polyamide, and the second insulation layer being polyurethane.

9. The wireless charging cable according to claim 8, wherein a thickness of the first insulation layer is within a range of 0.011 to 0.021 mm.

10. The wireless charging cable according to claim 8, wherein a thickness of the second insulation layer is within a range of 0.007 to 0.17 mm.

11. A method for producing a wireless charging coil structure comprising the following steps of:
preparing the wireless charging cable in claim 1; and
sewing the wireless charging cable on a sewed object, and sewing the wireless charging cable to become a wireless charging coil.

12. The method for producing the wireless charging coil structure according to claim 11, wherein after the step of preparing the wireless charging cable, the following step is that of inserting the wireless charging cable into a sewing needle.

13. The method for producing the wireless charging coil structure according to claim 11, wherein after the step of the wireless charging cable, the following steps are that of:
winding the wireless charging cable around a bobbin of a sewing machine;
preparing a fixing line for positioning an end of the fixing line at a needle head of the sewing machine; and
using the sewing machine to perform a double-thread interlocking sewing on the fixing line and the wireless charging cable.

14. The method for producing the wireless charging coil structure according to claim 11, wherein the wireless charging coil adopts a multi-strand parallel winding method, and has the plurality of wireless charging cables the plurality of the wireless charging cables are sewed on the sewed object at intervals.

15. A wireless charging coil structure, comprising:
a sewed object; and
preparing the wireless charging cable in claim 1, sewing the wireless charging cable on the sewed object and the wireless charging cable is sewed to become a wireless charging coil.

16. The wireless charging coil structure according to claim 15 further comprising a fixing line which is sewed on a first surface of the sewed object the wireless charging cable being sewed on a second surface of the sewed object the first surface and the second surface being corresponded with each other, the fixing line and the wireless charging wire being interlaced and interlocked up and down.

17. The wireless charging coil structure according to claim 15, wherein the wireless charging coil is a signal structure of a single-ended signal or a differential wiring.

18. The wireless charging coil structure according to claim 15, a material of the sewed object is selected from the group consisting of: cotton, nylon, linen, fiber, animal leather, pure wool, rayon, silk, acrylic, and artificial leather, and the sewed object is produced by the group consisting of: flat stitch, knitting, screw stitch, double reverse stitch, mesh stitch, raschel, elastic knitting, chemical bonding, hot-melt bonding and complexing.

19. A wireless charging device, comprising:
a first surface layer;
the wireless charging coil structure in claim 15, disposed on the first surface layer; and
a second surface layer covering the wireless charging coil structure and disposed on the first surface layer;
wherein the wireless charging coil of the wireless charging coil structure has an electronic connection end which is through the second surface layer and disposed on the second surface layer.

20. The wireless charging device according to claim 19 further comprising:
a charging module; and
a charging wire;
wherein the charging wire is electrically connected with the charging module, the charging module being disposed on the second surface layer the charging module being electrically connected with the electronic connection end.
